(19) United States
(12) Patent Application Publication
(10) Pub. No.: US 2009/0235353 A1
(43) Pub. Date: Sep. 17, 2009

(54) Scalable Hosting of User Solutions

(75) Inventors: Michael Ammerlaan, Sammamish, WA (US); Roger Francis Grambihler, Redmond, WA (US); William J. Griffin, Redmond, WA (US); Silviu Ifrim, Redmond, WA (US); Kristofer D. Hoffman, Redmond, WA (US); Hongzhou Ma, Redmond, WA (US); Dale Anson Rector, Redmond, WA (US); Randy David Thomson, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/049,316

(22) Filed: Mar. 15, 2008

(51) Int. Cl. G06F 21/20; G06F 9/445; G06F 9/46

(52) U.S. Cl. 726/22; 717/178; 718/105; 718/100

(57) ABSTRACT

Scalable hosting of user solutions is provided. A system for hosting application software includes a local server, one or more remote servers, a configuration database and a content database. The local server includes a web front end module that processes a request from a client computer over the Internet to host application software on a server. The web front end module determines whether the local server or the one or more remote servers will host the application software. The remote server includes a back end module that manages the installation and operation of application software hosted the remote server. The configuration database includes topology information that has descriptions of the server computers that can host application software. The content database includes information on the content of the software applications to be hosted on a server computer.

### BACKGROUND

Increasingly software applications are being hosted on the Internet. Because customers frequently have specific requirements for their applications or need tailored customizations, there is a need to support custom software applications on the Internet. Therefore, Internet infrastructure providers need to be able to host a wide diversity of custom solutions and applications.

Security and performance are two factors that need to be considered by Internet infrastructure providers when hosting software applications. Because many software applications may be hosted on one computer, it is often difficult to ensure the reliability of the applications. One bad software application can contain malicious code that can comprise system security. In addition, a poorly designed software application can degrade system performance and impact other software applications running on the host computer.

### SUMMARY

The present disclosure relates to a system and methods for hosting software application code on a local server and on remote servers in a secure and scalable manner.

According to one embodiment, a hosting system includes a local server, one or more remote servers, a configuration database and a content database. The local server includes a web front end module that processes client requests over the Internet to host application software on a server computer. The application software is typically customized to a user's business, for example a doctor's office, and uploaded to the local server over the Internet. Each remote server includes a back end module that manages the installation and operation of application software hosted on that server.

The local server uses the resources of the configuration database and the content database to determine on which server the application software should be hosted. The application software may be hosted on the local server or it may be hosted on one of the remote servers. The selection of the hosting server is done in a manner to make the overall hosting solution scalable and secure.

According to another embodiment, a method for hosting application software on a server is provided. When a request is received from a client computer to run application software on a server where the application software is being uploaded from the client to a local computer, the software application is validated. A determination of a performance tier for the software application is made, a determination of a solution type for the software application is made, and a determination of a topology of available host computers is made. Using the performance tier, solution type and topology information along with a load balancing algorithm, a determination is made as to a server, either local or remote, on which the software application should run. The operation of the software application is monitored as it runs on the server.

According to another embodiment, a method for requesting software applications to be hosted on a server is provided. A request is initiated with a local server to host an application program on a server. A software application program is uploaded to the local server where the software application program includes customized features specific to an application solution. A load balancing algorithm is uploaded to the local server, and the load balancing algorithm provides a method for determining the server on which the software application should be hosted. A validation mechanism is uploaded to the local server, and the validation mechanism provides a method of determining whether the software application should be hosted.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### DESCRIPTION OF THE DRAWINGS

The accompanying drawings incorporated in and forming a part of the specification illustrate several aspects of the present disclosure, and together with the description serve to explain the principles of the disclosure. In the drawings:

FIG. 1 shows an example system for hosting software applications on a server.

FIG. 2 shows another example system for hosting software applications on a server.

FIG. 3 shows example functional modules for a local server.

FIG. 4 shows example functional modules for a remote server

FIG. 5 shows example functional modules for an example web front end module of a local server.

FIG. 6 shows example functional modules for an example back end module of a server.

FIG. 7 shows a flow chart for an example method for hosting a software application on a server.

### DETAILED DESCRIPTION

The present application is directed to systems and methods for hosting software applications in a scalable and secure manner. Software applications are run on remote hosts that are tiered by solution type and performance. The software applications are run in a sandboxed environment that limits the ability of potentially malicious software from impacting the resources of the host computer and of other software applications running on the host computer.

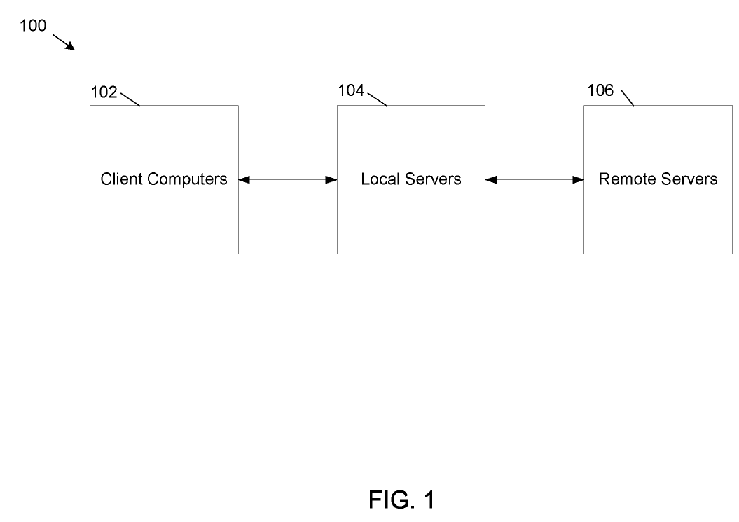

FIG. 1 shows an example computer system 100 including client computers (clients) 102, local servers 104 and remote servers 106. In an example embodiment, a client 102 uploads a custom software application to a local server 104 and requests that application software be hosted on a server. The local server 104 processes the request and determines which server is appropriate to host the application software. In some example embodiments, the local server 104 that receives the request will also host the application software. In other example embodiments, the local server 104 determines that the software application should be hosted on a remote server 106. The local server 104 makes this determination based on the solution type of the software application, the performance characteristics of the software application and the topology of the local servers and remote servers in the system. The end result is a scalable system where the system is load balanced so that similar performing software applications and software applications offering similar solution types are matched to a server and in which software overhead is minimized.

In an example embodiment, the local servers 104 and remote servers 106 are part of an Internet based collaboration and document management system such as Microsoft Windows SharePoint Services (WSS). In another example embodiment, the local servers 104 and remote servers 106 are part of Microsoft Office. In another example embodiment, a local server 106 is a Microsoft SharePoint server. Other configurations are possible.

In example embodiments, a client 102 can be a personal computing device, such as a desktop or laptop computer, a personal data assistant, or a cellular telephone. A client 102 can include input/output devices, a central processing unit (“CPU”), a data storage device, and a network device. Typical input/output devices include keyboards, mice, displays, microphones, speakers, disk drives, CD-ROM drives, and flash drives. Computer readable media, such as the data storage device, provide for data retention. By way of example, computer readable media can include computer storage media and communication media. Computer storage media includes volatile and nonvolatile, removable and non-removable media implemented in any method or technology for storage of information such as computer readable instructions, data structures, program modules or other data. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. Among the plurality of information stored on the data storage device is a client operating system (“OS”) and client applications. The client OS is a program that manages the hardware and software resources of the client system. The client applications utilize the resources of a client 102 to directly perform tasks specified by the user. Other configurations for the clients 102 are possible.

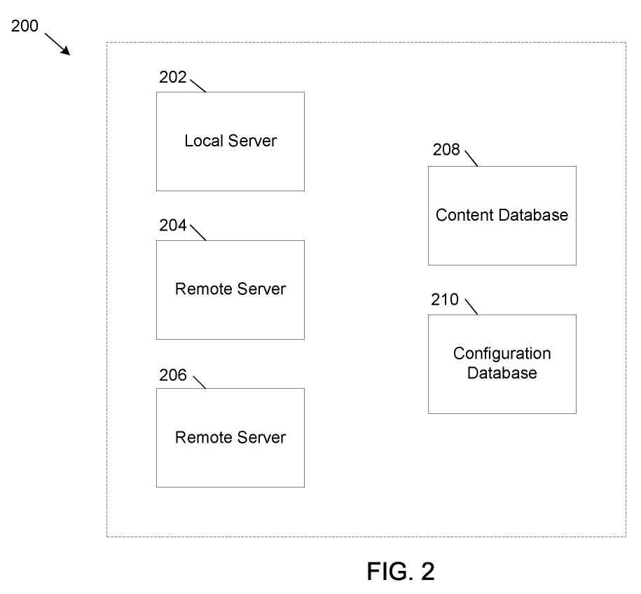

FIG. 2 shows an example system 200 for hosting software applications. The example system 200 includes local server 202, remote servers 204 and 206, content database 208 and configuration database 210. Local server 202 processes a request from a local client to host a software application. Local server 202 is illustrated in FIG. 2 as a single server, but it should be appreciated that numerous local servers 202 may be utilized to form a web farm of local servers. Thus, when the term server is used in any context herein, it should be understood to mean one or more servers that may be utilized as a combination or web farm of servers as capacity and performance needs dictate for any given system 200. Requests processed by the local server 202 often originate from businesses that want software applications tailored to their business made available to their customers over the Internet. Some example businesses are a dental office, a cleaner and a florist. The software applications to be hosted for these businesses can be classified into solution types. For example, a software application for a dental office has different characteristics than a software application for a florist. In addition, businesses having a common solution type often want to customize their software applications and add features specific to their business, for example to provide a specific display effect or to add custom controls or an event handler to handle specific business logic. Information regarding solution types for software applications used in the system is stored in content database 208 which may comprise one or more content databases.

When local server 202 processes the hosting request it makes a determination of where the software application should be hosted. This determination takes several factors into consideration. In a large scale system, thousands of applications may be hosted. Because many of these applications have the same solution type, it enhances system efficiency if applications with a common solution type are hosted together. It also improves system efficiency if a software application is not hosted on the local server that processes requests from clients. To this end and to improve system scalability, software applications may be hosted on remote servers like remote servers 204 and 206. It will be understood that in a large scale system there may be thousands of remote servers but in the example system of FIG. 2 only two are shown.

Still referring to FIG. 2, configuration database 210 contains information on the topology of the system including the software solution being hosted on local server 202 and on remote servers 204 and 206. The content database 208 contains information on the solution type and on the performance characteristics of each solution type. Local server 202 uses information obtained from content database 208 and configuration database 210 in conjunction with a load balancing algorithm to determine whether the software application should be hosted on local server 202 or on remote servers 204 and 206. Once this determination is made, local server 202 routes the software application to the appropriate destination.

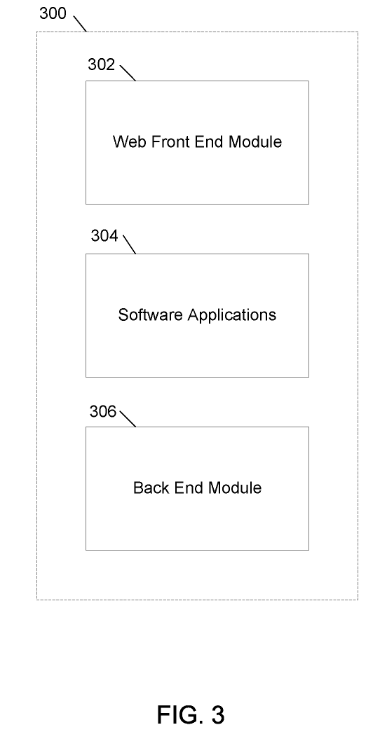

FIG. 3 shows some of the modules of an example local server 300. Included are web front end module 302, software applications module 304 and back end module 306. The web front end module 302 processes requests from clients to host software applications, makes a determination of where the software application is to be hosted and routes the software application to the appropriate destination. The local server may also host software applications 304 itself and therefore may also include back end module 306. The back end module 306 manages the execution of software applications 304 on local server 300.

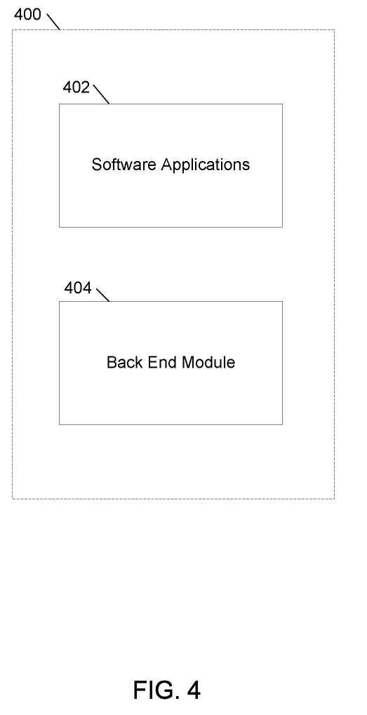

FIG. 4 shows some of the modules of an example remote server 400. Included are software applications module 402 and back end module 404. Remote server 400 does not include a web front end and therefore does not have the software overhead associated with a web interface. Back end module 404 manages the execution of software applications 402 on remote server 400.

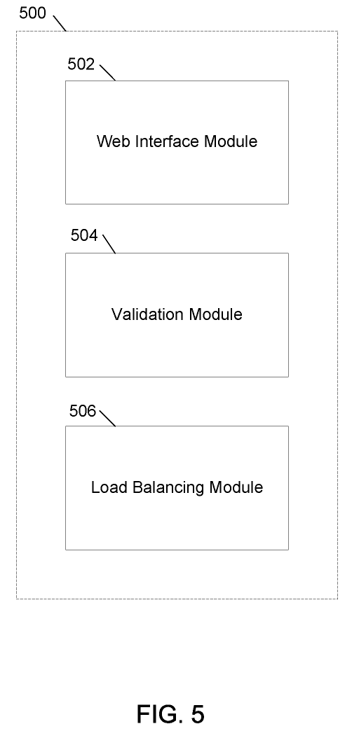

FIG. 5 shows an example web front end module 500. Web front end module 500 includes a web interface module 502, a validation module 504 and a load balancing module 506. The web interface module 502 receives requests from clients to host application software and manages the assignment of where the software is to be hosted. The validation module 504 determines if the application software is safe to run and whether it should be permitted to be hosted on a server computer. For example, the validation module may check a list of known safe software applications and ensure that the software application to be hosted is on this list. The validation module also includes an extensibility feature that permits or allows customers to supply custom solution validators unique to their software application solution. In this way, if a customer identifies an area of their software application code they are concerned about, for example, security, they can provide custom validation logic to check security. According to an embodiment, such solution validators may be customized solutions or may be obtained from third party vendors.

The load balancing module 506 uses one or more algorithms to assign software applications to hosts in an efficient and scalable manner. In one example embodiment, a load balancing algorithm is based on the frequency of use of a software application. In this example, the load balancing module 506 keeps track of incoming requests, storing the solution type and where the software application is assigned to be hosted. A calculation is made on frequency of requests for each solution type for a specified number of requests. So, for example, if over the last 10,000 requests, solution type A comprised 60% of these 10,000 requests, if a new request is received for solution type A, the software application for this request is mapped to host computers according to the same distribution of host computers as for the previous requests for solution type A. Thus, the new request is more likely to be directed to a host computer that already hosts other applications using solution type A.

In another example embodiment, a load balancing algorithm assigns software application solutions to performance tiers based on the cost of usage. For example, solutions with the worst performance characteristics, as measured by their previous usage of resources, are routed to the lowest performance tier. Software application solutions are assigned a usage penalty based on performance so that the worst performing solutions become too expensive to run. This “washing out” of poor performing solutions encourages overall system health. In addition, because poor performing solutions share a tier with other poor performing solutions, any disruptions to service (i.e. a solution which is terminated because of poor performance) is isolated to impacting other poor performing solutions.

The load balancing mechanism is extensible. Customers can provide their own load balancing algorithm, based on a generic template that can tailor the load balancing more specifically to their needs.

As an additional means to ensure scaling in the hosting system, solutions are also load balanced using a hashing algorithm. The hashing algorithm identifies solutions and the load balancing module routes them to server computers based on this hash. For example, if a software application to be hosted represents a solution already hosted on a server computer, the hashing algorithm prevents the same solution from being hosted on another server. This reduces the overhead of having the same software application hosted on two different host computers.

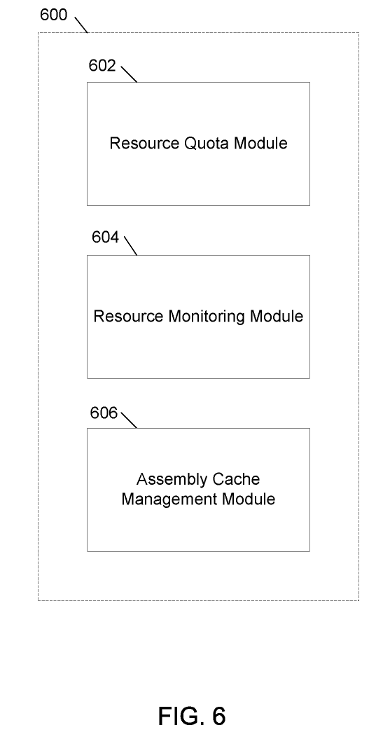

FIG. 6 shows an example back end module 600. Back end module 600 includes a resource quota module 602, a resource monitoring module 604 and an assembly cache management module 608. The resource quota module 602 is used to track and charge system resources back to host sites. Because site administrators are penalized and solutions do not run if a site exceeds a resource quota, the site administrator is incentivized to ensure that the solutions they use are running properly. Server computers that host applications (host sites) are provided a resource quota for system resources such as CPU usage, database usage, memory usage, etc. and these resources are tracked against a daily allotted value. An example quota is presented to the user as a percentage of the daily allotted value of the most used resource. For example, if a solution uses 70% of its database resources and 60% of its CPU resources, the quota for the day is presented as 70% to the user.

The resource monitoring module 604 monitors the resources used by software application solutions and determines whether resource quotas are exceeded. If a resource quota is exceeded, for example, if a solution uses more than its quota of memory, the solution is terminated. The use of resource monitoring in this manner is a proactive way to prevent system problems. For example, if a process goes into an infinite loop so that it continues to run, potentially for hours on end, the use of resource monitoring will terminate the process before overall system performance suffers and before system resources become depleted.

The assembly cache management module 608 manages the installation and running of custom software applications from a client. Assemblies are containers of custom code. In the assembly cache management module 608, a host service process manages the assemblies of custom code and manages how that code should be run on a server computer. The assembly cache management module 608 ensures that an assembly is loaded onto a remote server when needed and unloaded when not needed. In addition, a worker process manages the actual execution of that code.

The back end module 600 is run in a sandboxed environment, using an isolated infrastructure, to ensure that the software applications are run in a secure manner. The worker process is created with a restricted security token that limits access to system resources and to other software applications. In this manner, the system impact of malicious application code is limited.

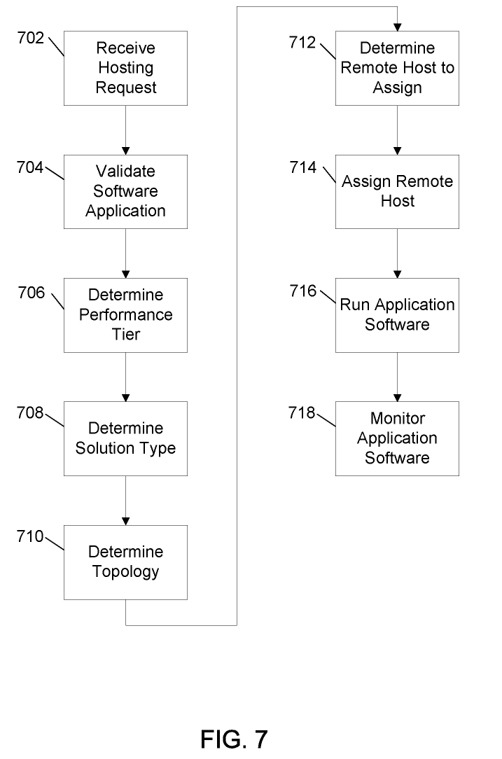

FIG. 7 is a flowchart showing an example method for hosting software applications on a server. At operation 702, a request to host a software application is received at a local server. An example is a user of Microsoft SharePoint who uploads a custom software application to a SharePoint site. At operation 704 the local server validates the application software, checking to make sure that it is safe to use on a server. For example, a software application may be validated by checking to make sure that it is on a safe list of software applications or by using a code-based validation program.

Once the software application has been validated, the local host makes a determination of which server should host the application software. This is a multi-operation process. First, at operation 706 a performance tier is determined for the software application. From an efficiency standpoint, it is best to host similar performing software applications on the same server. In this way, a poor performing application will not impact a faster running application on the same server. Next, at operation 708 a solution type is determined for the software application. It is also efficient and improves scalability to group similar applications together. In addition, it is important to know if a software application to be hosted is already hosted on the system. One way to make this determination is via a hashing algorithm that determines a unique hash value for each software application. If a request is made to host an application that has already been hosted, the hash numbers will match, informing the local server that this application has already been hosted.

Next, at operation 710 the local server obtains topology information from a configuration database to determine which software applications are hosted on which remote servers. At operation 712, the local server uses the performance tier, solution type and topology information in conjunction with a load balancing algorithm to determine which remote server, should host the software application. The result of this determination is that similar solution types and similar performing applications are grouped together. At operation 714, a remote server is assigned to host the application software based on this determination. It is also possible, based on the determination, that the software application could be hosted on the local server instead of a remote server.

At operation 716, the application software is run, and at operation 718, the application software is monitored. Monitoring the application software comprises determining whether resource quotas assigned to the software are not being exceeded. If it is determined, that a resource quota is being exceeded, the software application is terminated.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system for hosting application software, the system comprising:
a local server, wherein the local server includes a web front end module that processes a request from a client computer over the Internet to host application software on a server, the application software customized to a user's business, the application software uploaded to the local server over the Internet, the application software included in custom code modules that can be installed on the local server or on a remote server;
one or more remote servers, wherein a remote server includes a back end module that manages the installation and operation of application software hosted on the remote server;
a configuration database that includes topology information, the topology information including descriptions of the servers that can host application software; and
a content database, the content database including information on the content of the software applications to be hosted on a server;
wherein the web front module determines which of the local server or the one or more remote servers will host the application software.

2. The system of claim 1, wherein the local server further includes a load balancing module, the load balancing module assigning software applications to servers based on the performance cost of the software application.

3. The system of claim 2, wherein software applications are grouped according to tiers based on their performance characteristics.

4. The system of claim 2, wherein the load balancing module is extensible, the load balancing module allowing a user supplied framework to assign software applications to specific servers.

5. The system of claim 1, wherein the local server further includes a validation module operative to determine whether the application software is safe to run and whether the application software should be permitted to be hosted on the one or more remote servers.

6. The system of claim 5, wherein the validation module is extensible, the validation module including one or more solution validators that determine if a software application may be safely loaded onto and operated on a server.

7. The system of claim 1, wherein the back end module includes a resource quota module, the resource quota module providing a quota for system resources for each software application hosted on the one or more remote servers.

8. The system of claim 1, wherein the back end module includes a resource monitoring module, the resource monitoring module determining if resources used by a software application exceed a resource quota.

9. The system of claim 1, wherein the back end module includes an assembly cache management module, the assembly cache management module managing the custom code modules to ensure that they are loaded when needed and unloaded when not needed.

10. The system of claim 1, wherein a software application is run using an isolated infrastructure, the isolated infrastructure limiting access to system resources on the server and preventing the software application from adversely impacting system resources on the server.

11. A method for hosting a software application on a server, the method comprising:
receiving a request from a client computer to run a software application on a server, the software application including customized components, the customized components allowing the software application to be tailored to a specific business;
validating the software application;
determining a performance tier for the software application;
determining a solution type for the software application;
determining a topology of available host computers;
using the performance tier, the solution type, the topology and a load balancing algorithm to determine a remote server on which the software application should run;
assigning the software application to a remote server based on the determination of a remote server on which the software application should run;
running the software application on the assigned remote server; and
monitoring the running of the software application on the remote server.

12. The method of claim 11, further comprising validating the software application using validation criteria provided by a third party.

13. The method of claim 12, wherein validating the software application comprises using validation criteria provided by one or more solution validators operative to determine if the software application may be safely loaded onto and operated on the remote server.

14. The method of claim 11, wherein the performance tier is determined using a framework provided by a third party.

15. The method of claim 11, wherein the solution type is determined by a hashing algorithm.

16. The method of claim 11, wherein a resource quota is provided for the system resources on a remote server.

17. The method of claim 16, wherein resources on a remote server are monitored to determine if the resources exceed a resource quota.

18. The method of claim 17, wherein a software application is terminated if its resources exceed a resource quota.

19. The method of claim 11, further comprising a host service process that manages the execution of the customized components and a one or more worker processes that execute code associated with the customized components.

20. A computer readable medium containing computer executable instructions which when executed perform a method for requesting software applications to be hosted on a server, the method comprising:
initiating a request with a local server to host an application program on a server;
uploading a software application program to the local server, the software application program including customized features specific to an application solution;
uploading a load balancing algorithm to the local server, the load balancing algorithm providing a method for determining the server on which the software application should be hosted; and
uploading a validation mechanism to the local server, the validation mechanism providing a method of determining whether the software application should be hosted.
